(19) United States
(12) Patent Application Publication
(10) Pub. No.: US 2022/0188669 A1
(43) Pub. Date: Jun. 16, 2022

(54) PREDICTION METHOD FOR SYSTEM ERRORS

(71) Applicant: National Taiwan University, Taipei (TW)

(72) Inventors: Phone LIN, Taipei (TW); En-Hau YEH, Taipei (TW); Xin-Xue LIN, Taipei (TW)

(73) Assignee: National Taiwan University, Taipei (TW)

(21) Appl. No.: 17/338,661

(22) Filed: Jun. 3, 2021

(30) Foreign Application Priority Data
Dec. 10, 2020 (TW) 109143631

(51) Int. Cl. G06N 5/04; G06N 20/00

(52) U.S. Cl. CPC G06N 5/04; G06N 20/00

(57) ABSTRACT

The present invention discloses a prediction method for system errors, applied in prediction system predicting system errors of a monitored system. The method comprises steps of: pre-processing training data formed with data points at time slots to generate corresponding features to the data points of each time slot, and extract a frequency-based feature for each time slot according to distribution of clustering, grouping or classification of the corresponding features in the previous time slot of the current time slot. Using machine learning algorithm and taking model building data coming from the corresponding features and frequency-based feature as input to build up a prediction model for predicting and alerting a future error of the monitored system.

### FIELD OF THE INVENTION

The present invention generally relates to a prediction method. Specifically, the prediction method relates to building a prediction model based on a frequency-based feature.

### BACKGROUND OF THE INVENTION

When monitoring or detecting errors from a monitored system, it will face unbalanced quantity of system status due to far less number of status of error than number of normal status. This means that information representing an error in the monitored system is much less than that representing that the monitored system is normal. In a prediction system which uses a machine learning algorithm to identify system status, aforesaid unbalance will affect accuracy of the prediction to raise possibility of errors. Therefore, how to effectively predict occurrence of a future error in the monitored system with scarce status of error, and issue an alarm for errors are objects in information industry.

### SUMMARY OF THE INVENTION

An object of the present invention is to provide a prediction method for system errors which is capable to extract a frequency-based feature according to distribution of clustering, grouping or classification of corresponding features in a previous time slot of a current time slot, so as to improve efficiency of a machine learning algorithm, even with scarce status of system errors. Further, the prediction method may facilitate predicting and alerting a future error of the monitored system.

According to an aspect of the present invention, a prediction method for system errors, applied in a prediction system comprising a processing unit for predicting and alerting an error of a monitored system, the prediction method comprising steps of: pre-processing, with the processing unit, training data formed with a plurality of data points at a plurality of time slots to generate corresponding features to the data points of each time slot, and extracting a frequency-based feature for each time slot according to distribution of clustering, grouping or classification of the corresponding features in the previous time slot of a current time slot; and using, with the processing unit, a machine learning algorithm and taking model building data coming from the corresponding features and the frequency-based features as input to build up a prediction model for predicting and alerting a future error of the monitored system.

### BRIEF DESCRIPTION OF THE DRAWINGS

FIG. 1 shows block diagram of a prediction system and a monitored system monitored by the prediction system according to the invention, the prediction system being adapted to apply a prediction method for system errors an example of which is shown in FIG. 2;

FIG. 2 illustrates a flow chart of a prediction method for system errors according to an embodiment of the invention;

FIG. 3 shows an example performing a sub-step S1-2 of a prediction method for system errors according to an embodiment of the invention; and

FIG. 4 shows an example performing a sub-step S1-3 of a prediction method for system errors according to an embodiment of the invention.

### DESCRIPTION OF EMBODIMENTS OF THE INVENTION

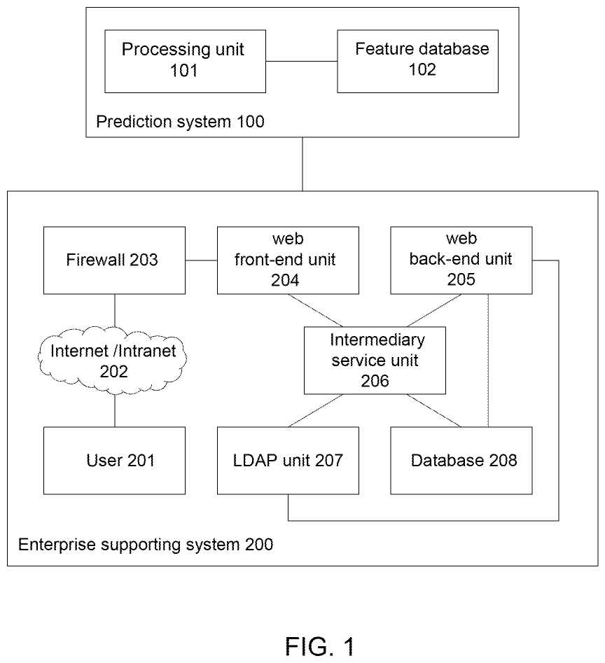

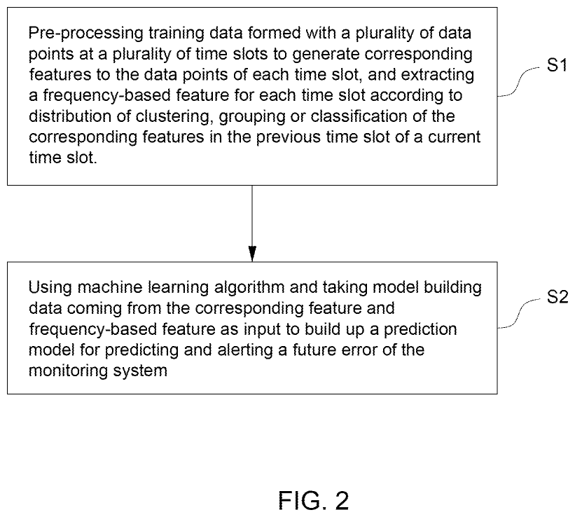

The present specification discloses several examples of a prediction method for system errors. Please refer to FIGS. 1 and 2, in which FIG. 1 shows block diagram of a prediction system and a monitored system monitored by the prediction system according to the invention, the prediction system being adapted to apply a prediction method for system errors an example of which is shown in FIG. 2, and FIG. 2 illustrates a flow chart of a prediction method for system errors according to an embodiment of the invention. Please note that the prediction system is merely one of exemplary systems applying the prediction method for system errors, and it is not intended to limit the prediction method for system errors. The prediction system 100 is used for predicting and alerting a monitored system 200 comprising a processing unit 101 and a feature database 102 coupling to the processing unit 101. The processing unit 101 is configured to perform the prediction method for system errors as shown in FIG. 2 in which a machine learning algorithm for prediction status of error of the monitored system 200 is used. Preferably, the processing unit 101 may periodically perform the prediction.

An enterprise supporting system which is an electrical system supporting production, management and surveillance of an enterprise may be taken as an example of the monitored system 200; however, the enterprise is not limited to a certain industry. In the present example, the enterprise supporting system is an electrical system supporting product management, billing, payment and operation orchestration. In another example, the enterprise supporting system may be an electrical system supporting controlling of various sensors and controllers, management and monitoring production in a factory. The enterprise supporting system 200 may comprise for example but not limited to users 201, Internet/Intranet 202, a firewall 203, a web front-end unit 204, a web back-end unit 205, an intermediate service unit 206, a lightweight directory access protocol (LDAP) unit 207 and a database 208. Please note the internal operation and structure of the enterprise supporting system 200 are not limited to FIG. 1. OS (operating system) may be operated in a physical server of one of the users 201, Internet/Intranet 202, firewall 203, web front-end unit 204, web back-end unit 205, intermediate service unit 206, LDAP unit 207 and database 208. The users 201 may be coupled to the web front-end unit 204 through the Internet/Intranet 202 and the firewall 203, each of the web front-end unit 204, web back-end unit 205, LDAP unit 207 and database 208 may be coupled to the intermediate service unit 206, and the web back-end unit 205 may be coupled to the database 208. The feature database 102 of the prediction system 100 may receive and store various log data from the enterprise supporting system 200. The log data may record status of a specific physical unit in the enterprise supporting system 200 in chronological order. For example, WebFrontend.csv may record status of the web front-end unit 204, WebBackend_1.csv and WebBackend_2.csv may record status of the web back-end unit 205, IntermediateService.csv may record status of the intermediate service unit 206, Database_1.csv to Database_5.csv may record status of the database 208, and OS_1.csv and OS_2.csv may record status of the OS. These log data may be operably combined to be stored in the feature database 102 so as to form data points representing system status in time slots, such as at least one data point in each time slot. Here, the system status may be indicated by various values, each of which representing a type of system status. For example, 0 may represent status of normal, and 1 may represent status of error. In other examples, system status may be indicated by different values. Because reliability of the enterprise supporting system 200 is very well, only few data points represent status of error and most data points represent status of normal. Unbalanced data pool occurs. For example, the unbalanced data pool may comprise two data sets, and a number of one of the data sets is greater than that of the other one of the data sets, such as at least 10 times, 99 times, or even 99.925% of data points for status of normal in an experiment. Therefore, the prediction method for system errors as shown in FIG. 2 may be applied to improve efficiency of the machine learning algorithm for predicting and alerting a future error of the monitored system.

As shown in FIG. 2, the processing unit 101 is configured to perform the prediction method for system errors. At first, in Step S1, the processing unit 101 may pre-process the training data formed with the data points at the time slots to generate corresponding features to the data points of each time slot, and extract a frequency-based feature for each time slot according to distribution of clustering, grouping or classification of the corresponding features in the previous time slot of a current time slot. In the present embodiment, during performing Step S1, several sub-steps may be performed. To avoid from missing data points, a sub-step S1-1 may be performed first. The sub-step S1-1 is to fill in a missing data point in the training data with a predetermined datum. The predetermined datum may be but not limited to a value of −1. As such, an output A⁽¹⁾ may be generated.

Then, the processing unit 101 may perform a sub-step S1-2: generating the corresponding features to the data points of each time slot. When implemented the sub-step S1-2, the processing unit 101 may use information gain algorithm to reduce dimension of the training data, and then increase a weight of the data set the number of which is less, and choose the first A features in order of importance, from high to low, and the first B features in order of discreteness, from high to low, in the training data to generate the corresponding features to the data points of each time slot. Here, a i-th feature of Xⱼ⁽¹⁾ may be represented by Xⱼ⁽¹⁾(i), j=1, 2 . . . T, and Xⱼ⁽²⁾ may be derived with removing Xⱼ⁽¹⁾(i) from Xⱼ⁽¹⁾, and ∀i∉F_{A}∪F_{B}. As such, an output A⁽²⁾={(Xⱼ⁽²⁾, yⱼ)|j=1, 2 . . . T} may be generated.

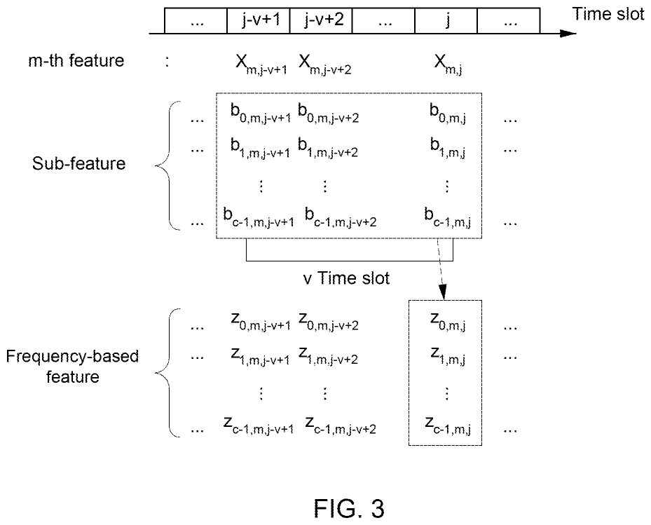

Then, the processing unit 101 may perform a sub-step S1-3: extracting the frequency-based feature for each time slot according to distribution of clustering, grouping or classification of the corresponding features in the previous time slot of the current time slot. When implemented the sub-step S1-3, the processing unit 101 may use a clustering algorithm to calculate the distribution of the corresponding features. The clustering algorithm may comprise at least one of K-means clustering algorithm and Gaussian mixture model (GMM) algorithm. Here, K-means clustering algorithm is used for example. Please refer to FIG. 3, which shows an example performing a sub-step S1-2 of a prediction method for system errors according to an embodiment of the invention. Specifically, the processing unit 101 may determine that if the corresponding features of each time slot j−v+1, j−v+2, . . . j are discrete features. If the corresponding feature are not discrete features, K-means clustering algorithm may used to classify the corresponding features into c groups. If the corresponding features of the current time slot are discrete feature, one-bit actual coding may be applied to the distribution of the corresponding features for transformation from c-class feature to c-dimension vector. The c-dimension vector may comprise c sub-features, a m-th sub-feature in a j-th time slot may be represented by (b_{0,m,j}, b_{1,m,j}, . . . , b_{c-1,m,j}), in which b_{k,m,j}=I_{[xm,j belonging to group K]}, k=0, 1, . . . , c−1, and I means indicator function. Then, a mean of every sub-feature in a FFC sliding window may be calculated to extract the frequency-based feature. When the current time slot is the j-th time slot, the FFC sliding window comprises a (j−v+1)-th time slot, a (j−v+2)-th time slot . . . and the j-th time slot. A feature vector z_{m,j} of the frequency-based feature of the m-th feature in the j-th time slot is defined as: z_{m,j}=(z_{0,m,j}, z_{1,m,j}, z2_{m,j}, . . . z_{c-1,m,j}),

$${z}_{k , m , j} = ( \frac{1}{v} ) {\sum }_{i = j - v + 1}^{j} {b}_{k , m , i} ,$$

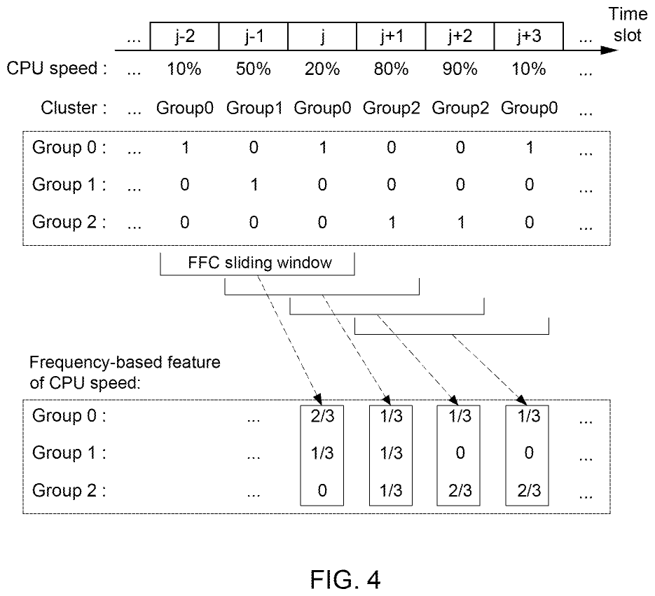

and k=0, 1, . . . , c−1. Please refer to FIG. 4, which shows an example performing a sub-step S1-3 of a prediction method for system errors according to an embodiment of the invention, in which CPU speed is taken for example with the assumption that c=3 and a time slot number of FFC sliding window v=3. The frequency-based feature in the j-th time slot may depend on the clustering result of the data points of CPU speed in the (j−2)-th, (j−1)-th, j-th time slots delimited by the FFC sliding window. For the j-th time slot, there are two time slots having abnormal value, 1, in a group 0, and one time slot having abnormal value, 1, in a group 1, and therefore, the frequency-based features in order of groups, from group 0 to group 2, are 2/3, 1/3, 0/3. When j−v+1<1 is satisfied, for the j-th time slot, j satisfies 1≤j≤v−1, and the FFC sliding window may comprise a time slot which is prior to start-up of the system. To avoid the unrealistic time slot, here, the sub-step S1-3 will be performed for the data points in the time slots after the v-th time slot only.

After the sub-step S1-3, the processing unit 101 may perform a sub-step S1-4: normalizing of the frequency-based feature. As such, a biased training result may be prevented after training with the machine learning algorithm. Then, the processing unit 101 may perform a sub-step S1-5: combining the normalized frequency-based feature and the corresponding features. The feature vector of the frequency-based feature of the m-th feature in the j-th time slot is z_{m,j}, and a dimension of a data set X⁽²⁾={Xⱼ⁽²⁾)|j=1, 2 . . . T} is Dim (X⁽²⁾). Combining Xⱼ⁽²⁾ and z_{m,j}, 1≤m≤Dim (X⁽²⁾), and Xⱼ⁽³⁾ may be derived. As such, an output A⁽³⁾={(Xⱼ⁽³⁾, yⱼ)|j=v, v+1, v+2 . . . T} may be generated.

After the sub-step S1-5, the processing unit 101 may perform a sub-step S1-6: slicing the feature vector from the frequency-based feature and the corresponding features with a predetermined window in chronological order to generate the model building data. For example, the j-th, (j−1)-th, (j−2)-th, . . . (j−w+1)-th time slot, the total number of which may depend on the size of the window, may be sliced from A⁽³⁾ for a j-th prediction. Therefore, Xⱼ⁽⁴⁾=(X_{j-w+1}⁽³⁾, X_{j-w+3}⁽³⁾, . . . , Xⱼ⁽³⁾) is generated, and an output A⁽⁴⁾={(Xⱼ⁽⁴⁾, yⱼ)|v+w−1≤j≤T} may be generated.

Then, in a step S2, the processing unit 101 may use a machine learning algorithm and take model building data coming from the corresponding features and the frequency-based features as input to build up a prediction model for predicting and alerting a future error of the monitored system. Specifically, one of random forest (RF) algorithm and support vector machine (SVM) algorithm may be used to generate the model building data with applying a greater weight to the data set in which the data number is less with the feature vector z_{m,j} of the frequency-based feature and the corresponding features of the j-th time slot, such as A⁽⁴⁾, as input, combined altogether.

Then, the processing unit 101 may use the prediction model to predict behaviors of the enterprise supporting system 200 with continuously input of the various log data of the enterprise supporting system 200. Here, the prediction may be implemented with a possibility of a behavior. For example, a leading system error which is not induced by anomaly of another system may be predicted with analyzing the log data. Therefore, the enterprise may receive accurate and timely alert for error even before a consecutive system error occurs. As mentioned above, according to the prediction method for system errors of the present embodiment, a frequency-based feature may be extracted according to distribution of clustering, grouping or classification of the corresponding features in the previous time slot of the current time slot, so as to improve the efficiency of the machine learning algorithm, even with scarce status of system errors. Further, the prediction method may facilitate predicting and alerting a future error of the monitored system.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims. For instance, it is possible to add bus buffers on a specific data bus if it is necessary. Moreover, it is still possible to have a plurality of bus buffers cascaded in series.

What is claimed is:

1. A prediction method for system errors, applied in a prediction system comprising a processing unit for predicting and alerting an error of a monitored system, the prediction method comprising steps of:
pre-processing, with the processing unit, training data formed with a plurality of data points at a plurality of time slots to generate corresponding features to the data points of each time slot, and extracting a frequency-based feature for each time slot according to distribution of clustering, grouping or classification of the corresponding features in the previous time slot of a current time slot; and
using, with the processing unit, a machine learning algorithm and taking model building data coming from the corresponding features and the frequency-based features as input to build up a prediction model for predicting and alerting a future error of the monitored system.

2. The prediction method according to claim 1, wherein the training data are an unbalanced data pool of two data sets, and a number of one of the data sets is at least 10 times greater than that of the other one of the data sets.

3. The prediction method according to claim 2, wherein the step of generating corresponding features to the data points of each time slot further comprising:
increasing a weight of the data set the number of which is less; and
choosing the first A features in order of importance, from high to low, and the first B features in order of discreteness, from high to low, in the training data to generate the corresponding features.

4. The prediction method according to claim 1, wherein the step of extracting a frequency-based feature for each time slot according to distribution of clustering, grouping or classification of the corresponding features in the previous time slot of a current time slot further comprising:
using a clustering algorithm to calculate distribution of the corresponding features;
extracting the frequency-based feature for each time slot according to the distribution of the corresponding features in the previous time slot of the current time slot;
normalizing of the frequency-based feature; and
combining the normalized frequency-based feature and the corresponding features.

5. The prediction method according to claim 4, wherein the clustering algorithm comprises at least one of K-means clustering algorithm and Gaussian mixture model algorithm.

6. The prediction method according to claim 4, wherein the step of using a clustering algorithm to calculate distribution of the corresponding features comprises:
using a clustering algorithm to calculate the distribution of the corresponding features and classifying the corresponding features into c groups when the corresponding features of the current time slot are not discrete feature; and
applying one-bit actual coding to the distribution of the corresponding features for transformation from c-class feature to c-dimension vector when the corresponding features of the current time slot are discrete feature, wherein the c-dimension vector comprises c sub-features, a m-th sub-feature in a j-th time slot is represented by (b_{0,m,j}, b_{1,m,j}, . . . , b_{c-1,m,j}), and b_{k,m,j}=I_{[xm,j belonging to group K]}, k=0, 1, . . . , c−1, and I means indicator function.

7. The prediction method according to claim 6, wherein the step of extracting the frequency-based feature for each time slot according to the distribution of the corresponding features in the previous time slot of the current time slot comprises:
calculating a mean of every sub-feature in a FFC sliding window to extract the frequency-based feature, and when the current time slot is the j-th time slot, the FFC sliding window comprises a (j−v+1)-th time slot, a (j−v+2)-th time slot . . . and the j-th time slot, and a feature vector z_{m,j} of the frequency-based feature of the m-th feature in the j-th time slot is defined as: z_{m,j}=(z_{0,m,j}, z_{1,m,j}, z2_{m,j}, . . . z_{c-1,m,j}),
$${z}_{k , m , j} = ( \frac{1}{v} ) {\sum }_{i = j - v + 1}^{j} {b}_{k , m , i} ,$$
and k=0, 1, . . . , c−1.

8. The prediction method according to claim 7, wherein the step of combining the normalized frequency-based feature and the corresponding features comprises:
combining the feature vector z_{m,j} of the frequency-based feature and the corresponding features of the j-th time slot.

9. The prediction method according to claim 8, wherein the step of using a machine learning algorithm and taking model building data coming from the corresponding features and the frequency-based feature as input to build up a prediction model for predicting and alerting a future error of the monitored system comprises:
using the machine learning algorithm comprising at least one of random forest algorithm and support vector machine algorithm to generate the model building data with applying a greater weight to a data set in which the data number is less with the feature vector z_{m,j} of the frequency-based feature and the corresponding features of the j-th time slot, combined altogether.

10. The prediction method according to claim 1, wherein the step of pre-processing training data formed with a plurality of data points at a plurality of time slots comprises:
filling in a missing data point in the training data with a predetermined datum; and
slicing the feature vector from the frequency-based feature and the corresponding features with a predetermined window in chronological order to generate the model building data.
